(19) United States
(12) Patent Application Publication
(10) Pub. No.: US 2011/0274308 A1
(43) Pub. Date: Nov. 10, 2011

(54) MULTIFUNCTIONAL MICRO SPEAKER

(75) Inventors: Sung-Hwan Doh, Gyeonggi-do (KR); Jae-Kyung Song, Seoul (KR); Jin-Hyuk Hong, Seoul (KR)

(73) Assignee: BSE CO., LTD., Incheon (KR)

(21) Appl. No.: 13/143,588

(22) PCT Filed: Aug. 31, 2009
(86) PCT No.: PCT/KR2009/004879

§ 371 Date: Jul. 7, 2011

(30) Foreign Application Priority Data
Jun. 24, 2009 (KR) 10-2009-0056547

(51) Int. Cl. H04R 11/02

(52) U.S. Cl. 381/398

(57) ABSTRACT

A multifunctional micro speaker including a frame; a diaphragm having an outer circumference portion fixed to the frame; a voice coil fixed to a lower surface of the diaphragm; a suspension fixed to the frame and having a predetermined elasticity; a yoke fixed to the suspension and including a receiving groove having a concave shape; a permanent magnet fixed to a bottom surface of the receiving groove; and a plate fixed to an upper surface of the permanent magnet, wherein a through hole is vertically formed through a central portion of a magnetic circuit including the yoke, the permanent magnet and the plate. The multifunctional micro speaker includes the through hole formed in a magnetic circuit, and thus, a vibration displacement of the magnetic circuit and a damping coefficient of the diaphragm may be controlled.

### TECHNICAL FIELD

One or more aspects of the present invention relate to multifunctional micro speakers, and more particularly, to a multifunctional micro speaker that has a magnetic circuit having an improved structure so as to control a vibration of a vibrator.

### BACKGROUND ART

A speaker is a device for converting an electrical signal into a voice signal. A micro speaker is a small-sized speaker used in small-sized portable audio devices such as cellular phones, notebook computers, MP3 players, earphones, and the like. Demand for such devices has risen sharply recently.

However, conventional electrical products employing a micro speaker, in particular, mobile communication devices such as cellular phones, indispensably include a component for generating a vibration. That is, a conventional mobile communication device includes a component for generating a vibration that is frequently used instead of a sound to indicate an incoming call, or includes a component for generating a vibration to indicate an input state in a touch screen method in which information is input directly by touching a screen.

A multifunctional micro speaker as claimed in the present application further includes a component for generating a vibration, in addition to including a component for generating a sound as in a conventional micro speaker. A multifunctional micro speaker is variously referred to as a multifunctional actuator, a multifunctional electrical sound converter, or the like.

A conventional multifunctional micro speaker is configured to generate a vibration by making a vibrator supported by a suspension as a plate-type spring resonate. The conventional multifunctional micro speaker includes a voice coil disposed in a magnetic circuit at a side of a diaphragm that is also referred to as a reed. Thus, when a voice signal current is supplied to the voice coil, the reed vibrates, and a sound is output. In addition, when a vibration signal current is supplied to the voice coil, the magnetic circuit as the vibrator (which includes a yoke, a permanent magnet, and a plate) vibrates, and a vibration is generated.

A conventional multifunctional micro speaker 100 will now be described with reference to FIG. 1. The conventional multifunctional micro speaker 100 includes a case 110, a diaphragm 101 for generating a sound, a voice coil 102, a permanent magnet 104 of which N and S poles are vertically arranged, a plate 103, a yoke 105, and a suspension 106. A current is supplied to the voice coil 102 through a lead wire a 114 and a lead wire b 115.

An upper end portion of the voice coil 102 is fixed to a lower surface of the diaphragm 101. The voice coil 102 is wound in a downward direction. The plate 103 is fixed to an upper surface of the permanent magnet 104. The permanent magnet 104, the plate 103, and the yoke 105 constitute a speaker magnetic circuit, and simultaneously, constitute a vibrator for generating a vibration. The yoke 105 is elastically supported against the case 110 by the suspension 106 having a disk shape with a through hole formed therein.

When a sound signal current is supplied to the voice coil 102 of the conventional multifunctional micro speaker 100 through the lead wire a 114 and the lead wire b 115, an electromagnetic force is generated in the voice coil 102, and thus, the diaphragm 101 vibrates and a sound is output. In addition, when a vibration signal current is supplied to the voice coil 102 through the lead wire a 114 and the lead wire b 115, the vibration signal current triggers an up-and-down motion of the speaker magnetic circuit (which is the vibrator) that further includes the permanent magnet 104, the plate 103, and the yoke 105, to thus generate a vibration.

However, in a conventional multifunctional micro speaker having such a general structure, damping of a vibrator is mainly performed by a suspension. Since damping performed by the suspension is in inverse proportion to a vibrating force or a resonance frequency, it is difficult to control the damping for reducing a displacement by a desired degree.

It is difficult to control a damping coefficient Q of the vibrator since an internal radiation impedance changes due to the vibration of the vibrator.

In addition, when the magnetic circuit and the vibrator vibrate simultaneously, a voice coil deviates from the magnetic circuit, and thus, an electrical damping force is reduced.

### DISCLOSURE OF THE INVENTION

### Technical Problem

One or more aspects of the present invention provide a multifunctional micro speaker that includes a through hole formed in a magnetic circuit, thereby controlling a vibration displacement of the magnetic circuit and a damping coefficient Q of a diaphragm.

### Technical Solution

According to an aspect of the present invention, there is provided a multifunctional micro speaker including a frame; a diaphragm having an outer circumference portion fixed to the frame; a voice coil fixed to a lower surface of the diaphragm; a suspension fixed to the frame and having a predetermined elasticity; a yoke fixed to the suspension and including a receiving groove having a concave shape; a permanent magnet fixed to a bottom surface of the receiving groove; and a plate fixed to an upper surface of the permanent magnet, wherein a through hole is vertically formed through a central portion of a magnetic circuit including the yoke, the permanent magnet, and the plate.

At least one mesh member may be disposed at the through hole.

The at least one mesh member may include a first mesh member disposed at an upper portion of the through hole, and a second mesh member disposed at a lower portion of the through hole.

The first mesh member and the second mesh member may have different thicknesses, different densities, or different materials.

The through hole may include a porous acoustic absorption member.

The through hole may include a permanent magnet through hole portion formed in the permanent magnet, a plate through hole portion formed in the plate, and a yoke through hole portion formed in the yoke, diameters of the plate through hole portion and the yoke through hole portion may each be greater than a diameter of the permanent magnet through hole portion, a porous acoustic absorption member may be disposed in the permanent magnet through hole portion, and the mesh member may be disposed on at least one of upper and lower surfaces of the porous acoustic absorption member.

### Advantageous Effects

According to one or more embodiments of the present invention, in a multifunctional micro speaker, a speaker magnetic circuit includes a through hole, and thus, damping coefficients of the speaker magnetic circuit and a vibrator, and a vibration displacement due to damping may be controlled.

In addition, since the speaker magnetic circuit includes mesh members fixed to the thorough hole, an additional damping force may be obtained.

In addition, since the speaker magnetic circuit includes a porous acoustic absorption member fixed to the thorough hole, a vibration mass and a sound load of the speaker magnetic circuit may be adjusted.

### BRIEF DESCRIPTION OF THE DRAWINGS

FIG. 1 is a schematic cross-sectional view of a conventional multifunctional micro speaker;

FIG. 2 is a schematic perspective view of a portion of a multifunctional micro speaker according to an embodiment of the present invention; and

FIG. 3 is a cross-sectional view of a multifunctional micro speaker according to another embodiment of the present invention.

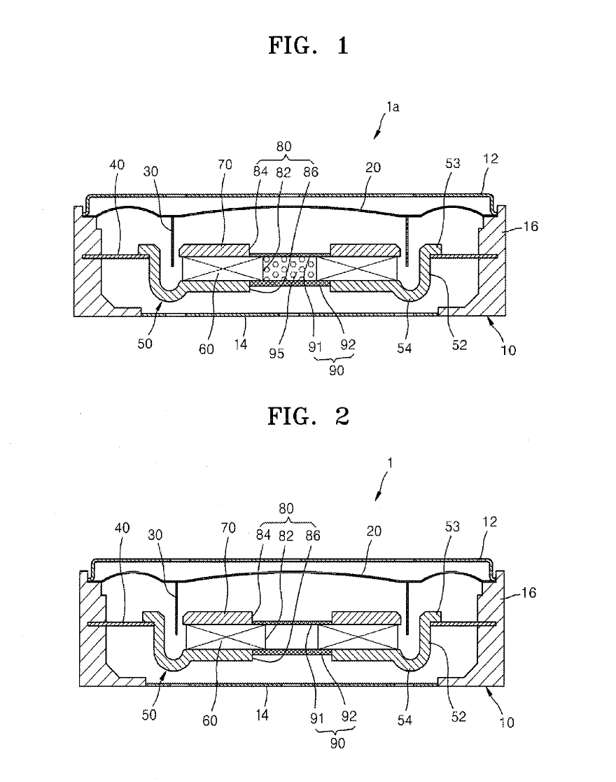

### BEST MODE FOR CARRYING OUT THE INVENTION

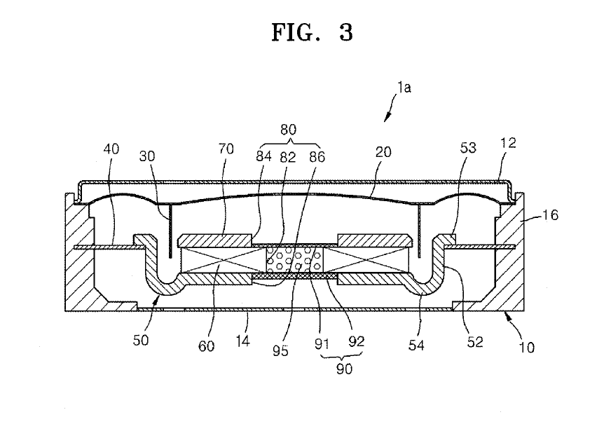

A multifunctional micro speaker according to an embodiment of the present invention will be described in detail with reference to FIG. 2.

FIG. 2 is a schematic perspective view of a portion of a multifunctional micro speaker 1 according to an embodiment of the present invention.

The multifunctional micro speaker 1 is mainly used in mobile communication devices such as cellular phones, or small-sized devices such as portable multimedia players (PMPs), and has both a function of generating a sound, like a speaker, and a function of generating a vibration as a signal.

The multifunctional micro speaker 1 includes a frame 10, a diaphragm 20, a voice coil 30, a suspension 40, a yoke 50, a permanent magnet 60, a plate 70, and a through hole 80.

The frame 10 is generally formed of plastic and forms an outer appearance of the multifunctional micro speaker 1. Various components are fixed to an inner part of the frame 10. The frame 10 includes an upper cover member 12 disposed thereon, and a lower cover member 14 disposed therebelow. A plurality of vents are formed through the upper cover member 12 and the lower cover member 14.

According to the present embodiment, the frame 10 has an overall cylindrical shape. However, according to another embodiment of the present invention, the frame 10 may have an overall rectangular-pillar shape that is unfilled and flat. When the frame 10 has a rectangular-pillar shape, components installed in the frame 10 may have a rectangular-pillar shape so as to correspond to the frame 10.

The diaphragm 20 generates a sound pressure audible to the human ears while vibrating vertically. An outer circumferential portion of the diaphragm 20 is fixed between a lateral wall 16 and the upper cover member 12 of the frame 10. The diaphragm 20 is generally formed of a high-molecular weight compound. The diaphragm 20 may be changed in various ways in terms of shape, material, and thickness.

The voice coil 30 is fixed to a lower surface of the diaphragm 20. The upper end portion of the voice coil 30 is fixed to a lower surface of a boundary portion between an inner portion and an outer portion of the diaphragm 20. The voice coil 30 is formed by winding a wire in an upward direction. The voice coil 30 is electrically connected to a terminal (not shown) included in the frame 10. The voice coil 30 receives a current from an external source thorough the terminal.

A lower portion of the voice coil 30 is disposed in a space (i.e., a magnetic gap) between the plate 70 and the yoke 50. When a high-frequency voice-signal current flows through the voice coil 30, the voice coil 30 moves up and down due to interaction between the high frequency current and a magnetic field formed by the permanent magnet 60. Thus, the diaphragm 20 coupled to the voice coil 30 vibrates to thus generate a sound.

The suspension 40 is formed of an elastic material. An outer circumference portion of the suspension 40 is fixed to the frame 10. The suspension 40 has a plate shape, for example, a disk shape so as to correspond to the shape of the frame 10.

The outer circumference portion of the suspension 40 is inserted into an inner lateral wall of the frame 10 so as to be fixed to the frame 10. A method of fixing the suspension 40 to the frame 10 may be changed in various ways. A hole is formed in a central portion of the suspension 40 so that the yoke 50 may be inserted into the hole and fixed to the suspension 40. The suspension 40 is formed of a plate-shaped metal material such as phosphor bronze. According to another embodiment of the present invention, the suspension 40 may be formed of a high-molecular weight elastic material.

The yoke 50 is formed of a material through which a magnetic force is smoothly transmitted. The yoke 50 is inserted into the hole formed in the central portion of the suspension 40 and is fixed to the suspension 40. The yoke 50 includes a concave receiving groove formed in an inner portion thereof. The yoke 50 includes a projection portion 53 that extends outwards from an upper end of a lateral wall 52 of the yoke 50 in a horizontal direction. The projection portion 53 curves over edges of the hole formed in the suspension 40 so as to be fixed to the suspension 40. According to the present embodiment, in order to prevent the voice coil 30 from colliding with a lower portion 54 of the yoke 50, which is positioned below the voice coil 30, during movement of the voice coil 30, the lower portion 54 of the yoke 50 has a convex shape that curves downwards, as shown in FIG. 2. According to another embodiment of the present invention, the lower portion 54 may not have a convex shape that curves downwards.

The permanent magnet 60 has a disk shape so as to be fixed to an inner portion of the receiving groove of the yoke 50. The permanent magnet 60 is fixed to an inner bottom surface of the yoke 50.

The plate 70 has a diameter slightly greater than the permanent magnet 60, and is fixed to an upper surface of the permanent magnet 60. The plate 70 is formed of a material through which a magnetic force is smoothly transmitted.

The permanent magnet 60 and the plate 70 are spaced apart from an inner lateral wall 52 of the yoke 50 and are fixed to the yoke 50. A space referred to as a magnetic gap is formed between the inner lateral wall of the yoke 50 and external lateral surfaces of the first permanent magnet 60. The lower portion of the voice coil 30 is disposed in the space.

The permanent magnet 60, the plate 70, and the yoke 50 constitute simultaneously a speaker magnetic circuit and a vibrator. A magnetic flux generated by the permanent magnet 60 forms a magnetic flux path that is transmitted to the yoke 50 through the plate 70.

The through hole 80 is vertically formed through a central portion of the speaker magnetic circuit including the yoke 50, the permanent magnet 60, and the plate 70. The through hole 80 is a vent through which air is capable of being transmitted. According to the present embodiment, the through hole 80 has a cylindrical shape. If necessary, the shape of the through hole 80 may be changed in various ways. In addition, an area of a lateral cross section of the through hole 80 may also be changed in various ways, in consideration of a damping degree.

The through hole 80 includes a permanent magnet through hole portion 82 formed in the permanent magnet 60, a plate through hole portion 84 formed in the plate 70, and a yoke through hole portion 86 formed in the yoke 50.

According to the present embodiment, diameters of the plate through hole portion 84 and the yoke through hole portion 86 are each greater than a diameter of the permanent magnet through hole portion 82 so as to easily fix a mesh member 90 to the through hole 80. According to another embodiment of the present invention, diameters of the plate through hole portion 84, the yoke through hole portion 86, and the permanent magnet through hole portion 82 may be the same or different as long as air may be vertically transmitted through the plate through hole portion 84, the yoke through hole portion 86, and the permanent magnet through hole portion 82.

According to the present embodiment, the through hole 80 includes the mesh member 90. The mesh member 90 is formed by connecting strands formed of various materials such as metal, or fiber so as to form various holes. Air may be transmitted through the mesh member 90. The mesh member 90 may include a mesh member having a plurality of holes that are vertically formed therethrough in addition to a mesh member formed of fiber, or the like.

According to the present embodiment, the mesh member 90 includes a first mesh member 91 formed at an upper end portion of the through hole 80, and a second mesh member 92 formed at a lower end portion of the through hole 80.

The first mesh member 91 is fixed to an upper portion of the permanent magnet through hole portion 82 formed in the permanent magnet 60. The first mesh member 91 is fixed to a lower inner portion of the plate through hole portion 84. The second mesh member 92 is fixed to a lower portion of the permanent magnet through hole portion 82. The second mesh member 92 is fixed to an upper inner portion of the yoke through hole portion 86.

The first mesh member 91 and the second mesh member 92 have different thicknesses. The first mesh member 91 and the second mesh member 92 may have different densities, that is, different density degrees.

Thus, an air layer is formed between the first and second mesh members 91 and 92. The air layer forms an air damping structure of the speaker magnetic circuit (which includes the yoke 50, the permanent magnet 60, and the plate 70) as the vibrator. Since the first mesh member 91 and the second mesh member 92 have different thicknesses, different densities, and different materials, the first mesh member 91 and to the second mesh member 92 may have different damping coefficients. Thus, a damping coefficient in a case where the speaker magnetic circuit moves up may be different from a damping coefficient in a case where the speaker magnetic circuit moves down.

According to another embodiment of the present invention, the first and second mesh members 91 and 92 may be formed of materials having the same density, and may have the same thickness. Densities and thicknesses of the first and second mesh members 91 and 92 may be changed in various ways, in consideration of required damping coefficients.

According to the present invention, the mesh member 90 includes two members disposed at the upper and lower portions of the through hole 80. Alternatively, the mesh member 90 may include only a single member disposed at any one of upper, lower and intermediate portions of the through hole 80.

Hereinafter, the operation and effect of the multifunctional micro speaker 1 will be described.

The multifunctional micro speaker 1 is characterized in that the through hole 80 is formed in the speaker magnetic circuit that vibrates. By changing the shape and size of the through hole 80, a vibration displacement of the speaker magnetic circuit as the vibrator and a damping coefficient Q of the vibrator may be adjusted to have desired degrees.

The multifunctional micro speaker 1 includes the first mesh member 91 and the second mesh member 92, which are disposed at the upper and lower portions of the through hole 80, respectively. Thus, the air layer formed between the first mesh member 91 and the second mesh member 92 forms the air damping structure due to impedance that is different from an outside environment.

Since the first mesh member 91 and the second mesh member 92 have different thicknesses and densities, the first mesh member 91 and the second mesh member 92 may have different damping coefficients when the speaker magnetic circuit moves up and down, respectively.

The first and second mesh members 91 and 92 disposed at the upper and lower portions of the through hole 80 may control an amount of airflow at a rear surface of diaphragm 20 so as to control the characteristics of the damping coefficient Q.

According to another embodiment of the present invention, the multifunctional micro speaker 1 may include only a through hole without a mesh member. Alternatively, the number, thicknesses, densities and materials of mesh members, and density of meshes of the mesh members may be changed in various ways.

FIG. 3 is a cross-sectional view of a multifunctional micro speaker 1a according to another embodiment of the present invention.

The multifunctional micro speaker 1a of FIG. 3 is different from the multifunctional micro speaker 1 of FIG. 2 in that the through hole 80 includes an acoustic absorption member 95 having pores. The acoustic absorption member 95 is formed of a material with many pores formed therein.

According to the present embodiment, the acoustic absorption member 95 is included in the permanent magnet through hole portion 82. The first and second mesh members 91 and 92 are disposed on upper and lower surfaces of the acoustic absorption member 95, respectively.

According to the present embodiment, since the acoustic absorption member 95 has its mass and is porous, the mass and sound load of the speaker magnetic circuit as the vibrator may be controlled. In addition, since the multifunctional micro speaker 1a includes the acoustic absorption member 95, and the first and second mesh members 91 and 92, air damping and sound load may be easily controlled to have desired degrees by adjusting the air damping and the sound load to have desired degrees.

In the multifunctional micro speaker 1a, the same operation and effect may be obtained due to the same construction except for that described above, as the multifunctional micro speaker 1 of FIG. 2.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A multifunctional micro speaker comprising:
a frame;
a diaphragm having an outer circumference portion fixed to the frame;
a voice coil fixed to a lower surface of the diaphragm;
a suspension fixed to the frame and having a predetermined elasticity;
a yoke fixed to the suspension and comprising a receiving groove having a concave shape;
a permanent magnet fixed to a bottom surface of the receiving groove; and
a plate fixed to an upper surface of the permanent magnet,
wherein a through hole is vertically formed through a central portion of a magnetic circuit comprising the yoke, the permanent magnet, and the plate.

2. The multifunctional micro speaker of claim 1, wherein at least one mesh member is disposed at the through hole.

3. The multifunctional micro speaker of claim 2, wherein the at least one mesh member comprises a first mesh member disposed at an upper portion of the through hole, and a second mesh member disposed at a lower portion of the through hole.

4. The multifunctional micro speaker of claim 3, wherein the first mesh member and the second mesh member have different thicknesses, different densities, or different materials.

5. The multifunctional micro speaker of claim 1 or 2, wherein the through hole comprises a porous acoustic absorption member.

6. The multifunctional micro speaker of claim 2, wherein the through hole comprises a permanent magnet through hole portion formed in the permanent magnet, a plate through hole portion formed in the plate, and a yoke through hole portion formed in the yoke,
wherein diameters of the plate through hole portion and the yoke through hole portion are each greater than a diameter of the permanent magnet through hole portion,
wherein a porous acoustic absorption member is disposed in the permanent magnet through hole portion, and
wherein the mesh member is disposed on at least one of upper and lower surfaces of the porous acoustic absorption member.
